(19) United States
(12) Patent Application Publication
(10) Pub. No.: US 2006/0130446 A1
(43) Pub. Date: Jun. 22, 2006

(54) Multi-function light and air filtration unit

(75) Inventor: Walter Herbst, Lake Forest, IL (US)

Correspondence Address: Thomas E. Young, Esq.;Fay, Sharpe, Fagan, Minnich & McKee, LLP, Seventh Floor, 1100 Superior Avenue, Cleveland, OH, 44114-2579, US

(73) Assignee: PRACTICAL TECHNOLOGIES, INC.

(21) Appl. No.: 11/259,670

(22) Filed: Oct. 26, 2005

Related U.S. Application Data
(60) Provisional application No. 60/637,003, filed on Dec. 20, 2004.

(51) Int. Cl. B01D 50/00

(52) U.S. Cl. 55/385.1

(57) ABSTRACT

The subject invention relates to combination lighting and air filtration units that provide illumination and filter air in a particular area. A lighting unit includes an illumination element and a housing with a rounded profile that encloses the illumination element. A conduit is adjacent to the housing wherein a filter is mounted within the conduit. An input fan draws air through the filter to produce filtered air and an output fan expels the filtered air.

### CROSS-REFERENCE TO RELATES PATENTS AND APPLICATIONS

This application claims the benefit of U.S. Provisional Patent Application Ser. No. 60/637,003 filed on Dec. 20, 2004 and entitled “Air Cleaner/Ceiling Light,” the entirety of which is incorporated by reference herein.

### BACKGROUND OF THE INVENTION

Various systems and methods are conventionally employed to illuminate spaces located in a building. Lighting can be provided directly, indirectly or diffusely depending on the space, purpose of illumination and user preference. In a standard configuration, an illumination device includes a housing, a mounting bracket and a light element receptacle. The housing can be fabricated utilizing any number of materials such as brass, aluminum, stainless steel, or any number of plastics. The light element receptacle can accept specific elements manufactured for such a purpose. Such element types include incandescent, halogen, compact fluorescent, fluorescent, high intensity discharge (HID) and the like.

For some applications, a multi-function device may be desired to provide one or more disparate features. For example, additional features such as air purification, smoke detection or ventilation may be desired. Conventionally, such multi-function devices employ non-functional designs that are well known in the art.

Air purification has conventionally been accomplished via ionic filtration systems or similar purification systems. However, ionic systems suffer from several functional drawbacks. One drawback is the excessive amount of ozone that is produced from ionic systems that can aggravate asthma and decrease lung function. Such harmful effects are caused by concentrated ozone levels which are generated by systems utilizing ionic filtration. Ozone concentration can reach deleterious levels since ionizers do not have to meet any standardized levels as they are not regulated by any governing body.

Conventional lighting and filtration devices suffer from several drawbacks such as excessive noise, inefficient design, awkward installation, incompatibility with electrical interfaces, difficult maintenance and the like. Such difficulties can be caused by inadequate or poor design and/or incorrect implementation of the lighting device. What are needed are systems and methods that address shortcomings associated with conventional lighting and filtration devices.

### BRIEF SUMMARY OF THE INVENTION

According to one aspect of the subject invention, a lighting unit includes an illumination element and a housing with a rounded profile that encloses the illumination element. A conduit is adjacent to the housing wherein a filter is mounted within the conduit. An input fan draws air through the filter to produce filtered air and an output fan expels the filtered air.

According to another aspect of the subject invention, a multi-function unit includes an illumination element and a housing with a rounded profile that encloses the illumination element. A conduit is adjacent to the housing and a combination HEPA-charcoal filtration element is mounted within the conduit. An input fan draws air through the filtration element to produce filtered air and an output fan expels the filtered air.

According to yet another aspect of the subject invention, a multi-function appliance includes at least one light bulb and a housing with that encloses the at least one light bulb. An indication lamp is proximate the illumination element and a personal computer board illuminates the indication lamp based on at least one predetermined condition. A conduit is adjacent to the housing and a combination HEPA-charcoal filtration element that is mounted within the conduit. An input fan draws air through the filtration element to produce filtered air and an output fan expels the filtered air. A fan speed regulator varies the speed of at least one of the input fan and the output fan.

### BRIEF DESCRIPTION OF THE DRAWINGS

The invention may take form in various components and arrangements of components, and in various steps and arrangements of steps. The drawings are only for purposes of illustrating the preferred embodiments and are not to be construed as limiting the invention.

FIG. 1 is an exterior side profile of a pillow light and air filtration unit in accordance with an exemplary embodiment.

FIG. 2 is an interior side profile of the pillow light and air filtration unit in accordance with an exemplary embodiment.

FIG. 3 is a bottom view of the pillow light and air filtration unit in accordance with an exemplary embodiment.

FIG. 4 is an end view of the pillow light and air filtration unit in accordance with an exemplary embodiment.

FIG. 5 is a cross-section view of the pillow light and air filtration unit in accordance with an exemplary embodiment.

FIG. 6 is a cross-section view of the pillow light and air filtration unit in accordance with an exemplary embodiment.

FIG. 7 is an exterior side profile of the pillow light and air filtration unit in accordance with an exemplary embodiment.

FIG. 8 is an interior side profile of the pillow light and air filtration unit in accordance with an exemplary embodiment.

FIG. 9 is an exterior side profile of a circular light and air filtration unit in accordance with an exemplary embodiment.

FIG. 10 is a top view of the circular light and air filtration unit in accordance with an exemplary embodiment.

FIG. 11 is an exterior side profile of the circular light and air filtration unit in accordance with an exemplary embodiment.

FIG. 12 is a detailed top view of the circular light and air filtration unit in accordance with an exemplary embodiment.

FIG. 13 is cross-section view of the circular light and air filtration unit in accordance with an exemplary embodiment.

FIG. 14 illustrates a fan for air filtration in accordance with an exemplary embodiment.

FIG. 15 is cross-section view of the circular light and air filtration unit in accordance with an exemplary embodiment.

FIGS. 16A and 16B illustrates two sides of an air filter in accordance with an exemplary embodiment.

### DETAILED DESCRIPTION OF THE PREFERRED EMBODIMENTS

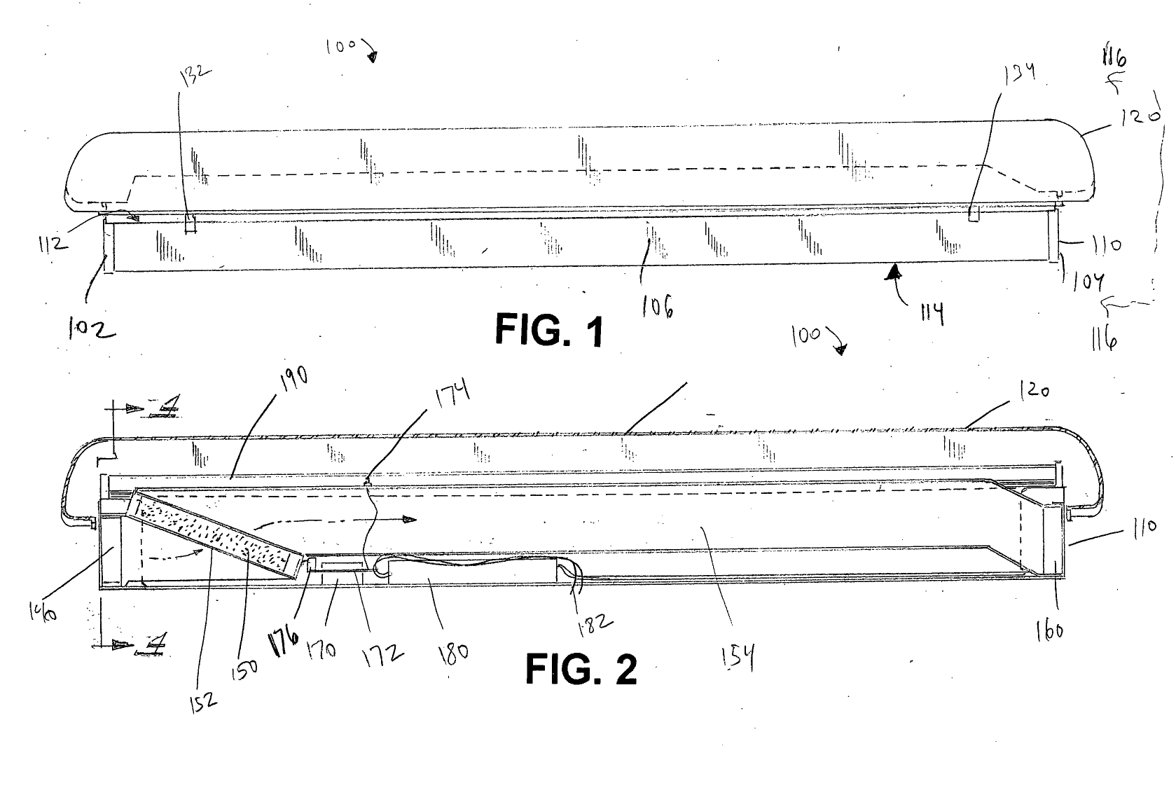

FIG. 1 illustrates an exterior side profile of a pillow light and air filtration unit 100 (PLF unit) which includes a base 110 and a lamp housing 120. Connectors 132 and 134 can be used to couple the base 110 with the lamp housing 120. The PLF unit 100 provides light and/or filters air. Air filtration is accomplished by drawing air through a filter residing within the PLF unit 100, filtering the air, and expelling the filtered air. The PLF unit 100 can be retrofitted into existing lighting and/or installed in new construction.

The base 110 is comprised of two pairs of walls 102, 104 and 106, 108 which are substantially parallel to form a box like shape. The top 112 of the base 110 is open to allow one or more air filtration and/or electrical components to connect to elements within the lamp housing 120. The electrical components can be located on the bottom 114 of the base 110 and employed to deliver power to one or more illumination elements, signal indicators and the like. The bottom 114 of the base 110 can have one or more apertures cut out to accommodate electrical and/or other wiring.

The base 110 is coupled to the lamp housing 120 utilizing the connectors 132, 134. The connectors 132, 134 can be spring clips, screws, rivets, etc. The lamp housing 120 has a round shape such that when the lamp is viewed from an end (e.g., 116), the base 110 and lamp housing 120 together create a mushroom profile. The lamp housing 120 is employed to disburse light and is preferably a translucent material. The base 110 allows mounting the PLF unit 100 to a flat surface such as a wall or ceiling, for example, and can have one or more mounting holes to allow fastening devices (e.g., screws) to secure the PLF unit 100 to a desired surface.

The lamp housing 120 is designed to provide a distinctive round profile that can be incorporated into substantially any contemporary design scheme. The lamp housing 120 can enclose one or more light bulbs in any number of configurations. In one embodiment, the lamp housing 120 can accommodate two fluorescent light bulbs. Such bulbs can be any size such as T4, T5, T8, etc. In addition, the lamp housing 120 can accommodate one or more incandescent bulbs, compact fluorescent bulbs, halogen bulbs, high intensity discharge bulbs and the like. Various combinations of bulbs can be employed to provide particular lighting schemes as desired.

The connectors 132 and 134 are employed to fasten the lamp housing 120 to the base 110. In addition, other connectors (not shown) located symmetrically on the base 110 can be employed to provide additional fastening support. The connectors 132 and 134 are designed to snap into place and are made of a flexible material. For example, the connectors 132 and 134 can be manufactured from metal, plastic or any desired composite material.

FIG. 2 illustrates an interior profile of the PLF unit 100 which includes the base 110 and the lamp housing 120. The PLF unit 100 further includes an input fan 140 which draws air through a filter 150. The filter 150 can be held in place utilizing a filter guide 152 and/or other means. The filtered air is drawn through a conduit 154 and expelled via an output fan 160. The fans 140 and 160 are located with the base 110 inset from the lamp housing 120 to minimize view of the air slots (e.g., 210 below) required for air movement. In one approach, the fans 140 and 160 are square shaped computer fans.

The filter 150 eliminates particulate matter and/or odor from the air. In this manner, surrounding air quality can be improved and/or provide relief from allergy and/or asthma causing irritants. The filter 150 can include a combination of High Efficiency Particulate Air (HEPA) filters and/or electrostatic filters. In addition, the filter 150 can include charcoal filtration which can be employed to eliminate odors. The filter guide 152 is oriented to provide simple replacement of the filter 150.

A fan speed regulator 170 controls the speed of the fans 140 and 160. Such fan speed can be regulated based on any number of factors such as a predetermined time interval, quality of air, length of filter use, etc. A PC board 172 can control output to a signal lamp based at least in part on received feedback values. The PC board 172 also toggles a signal lamp 174 that indicates when a predetermined condition has been met. In one example, the signal lamp 174 is illuminated after a predetermined time interval. In another example, the signal lamp 174 is illuminated when an air quality sensor (not shown) indicates that air quality has fallen below a predetermined value.

The signal lamp 174 provides notification that a condition exists that warrants attention from the user. One such condition can be the degradation of the air filter 150 and that the filter 150 needs to be replaced. The signal lamp 174 provides a distinct luminous output to allow interested personnel to locate and identify when the lamp is illuminated In one embodiment, the signal lamp 174 is a light emitting diode (LED) that outputs light. In this example, the LED can provide light that is bright enough to be detected by an interested observer but dim enough that it will not interfere with normal operation of the PLF unit 100. After the filter 150 has been replaced, a filter reset switch 176 is employed to notify the PC board 172 to reset one or more predetermined values for future filter replacement.

A ballast 180 provides regulated power to an illumination element 190. The ballast 180 typically is located in the base 1 10 and is connected to power lines 182 that interface to a power source (not shown). The illumination element 190 can be representative of one or more light bulbs according to various disparate designs. In one embodiment, the ballast 180 utilizes low power consumption to meet the requirements for the Energy Star program.

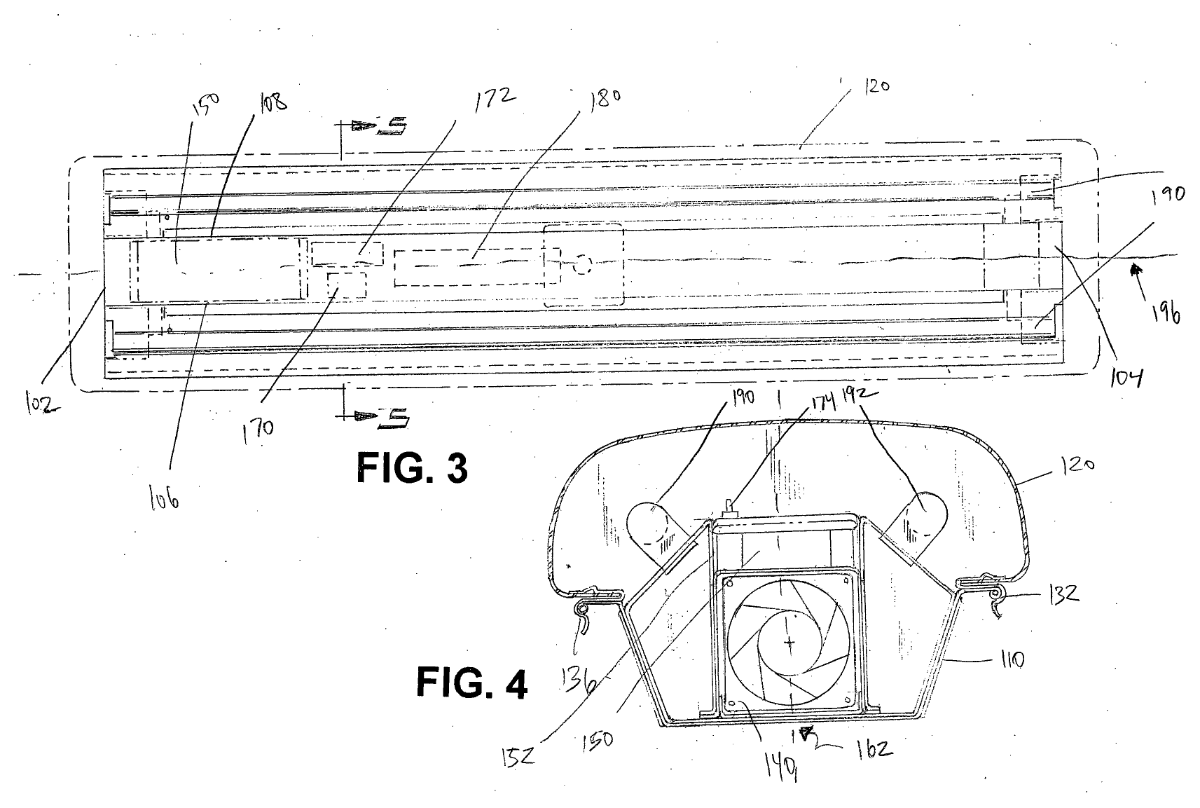

FIG. 3 shows a bottom view of the PLF unit 100 which includes an outline of the lamp housing 120. The filter 150 is located near one side of the PLF unit 100, adjacent the input fan 140. The fan speed regulator 170 and the PC board 172 are disposed near the filter 150. The ballast 180 is located to the right of the fan speed regulator 170 and the PC board 172. The illumination elements 190, 192 are disposed symmetrically from the centerline 196 of the PLF unit 100 to provide even lighting output. However, in another embodiment, 190 and 192 are disposed asymmetrically. In this embodiment, the illumination elements 190, 192 are fluorescent lamps.

FIG. 4 illustrates a cross sectional view of the PLF unit 100 as indicated in FIG. 2. The input fan 140 is located at the midline 162 of the PLF unit 100 is. The top of the filter 150 is located above the input fan 140 and angles downward behind the input fan 140 to force input air through the filter 150. The filter 150 is held in place via the filter guide 152. The filter guide 152 can be a metal or other rigid frame wherein the filter 150 is inserted and fixed into place. Connectors 132 and 136 secure the lamp housing 120 to the base 110. The signal lamp 174 is located on top of the filter 150 and is between the illumination elements 190, 192. However, the signal lamp 174 can be located in any viewable location to properly notify interested personnel.

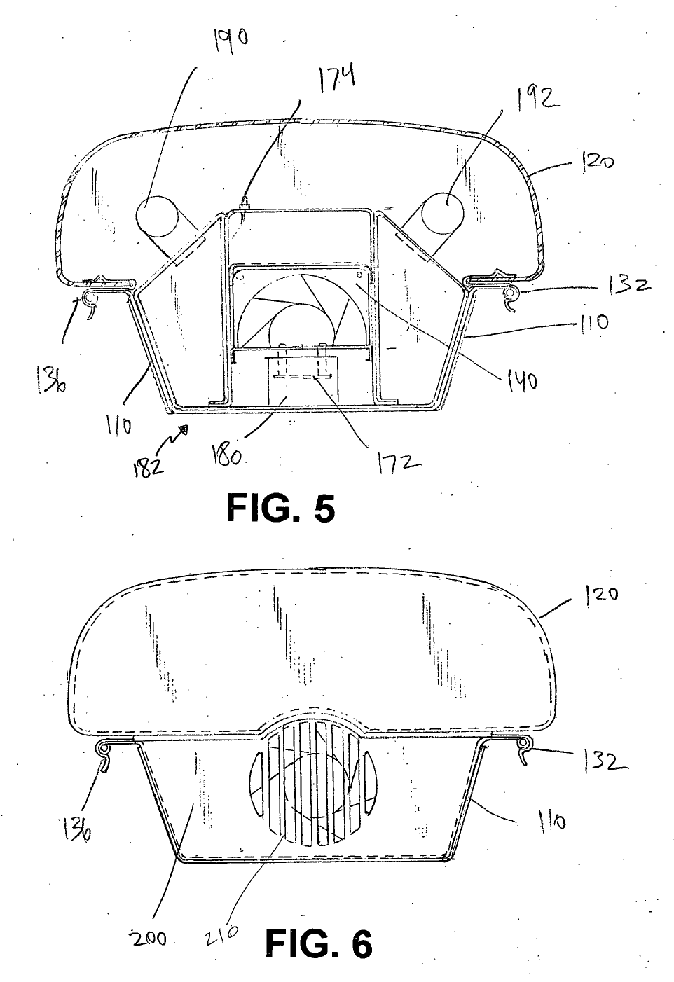

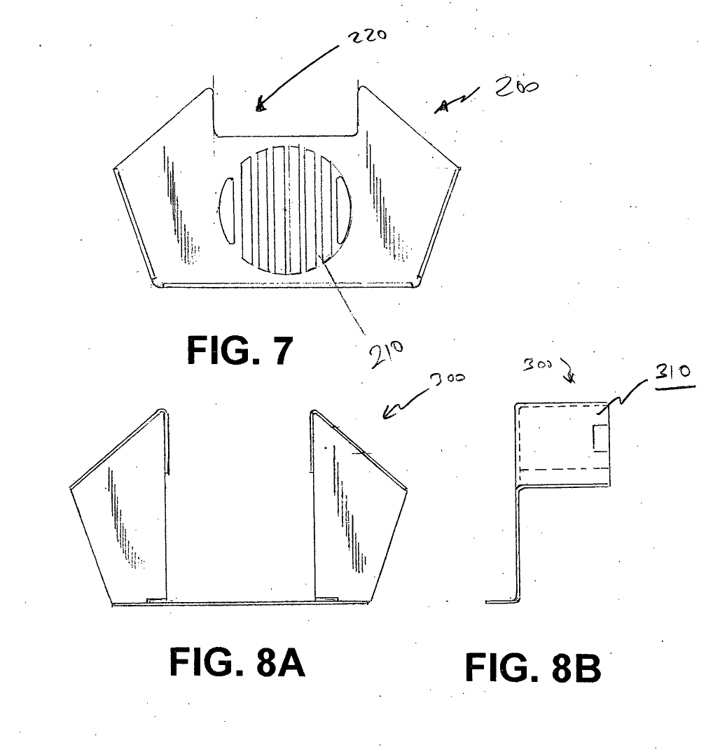

FIG. 5 illustrates a cross-sectional view of the PLF unit 100 as indicated in FIG. 3. The PC board 172 is located in the lower portion of the PLF unit 100. The ballast 180 is located on the floor 182 of the base 110 below the airway 154. FIG. 6 shows an end view of the PLF unit 100. The lamp housing 120 is coupled to the base 110 via connectors, two of which (132, 136) are shown. An end cap 200 is employed to enclose the end of the base 110 of the PLF unit 100. The end cap 200 contains a vent 210 to allow air to be drawn into the filter. 150 and can be manufactured of a rigid material such as steel or plastic. FIG. 7 shows a detail of the end cap 200 which contains several slots 205 to accommodate air flow through the vent 210. As depicted, the general shape of the end cap 200 is hexagonal with a recessed feature 220 in the top to provide access to the filter 150 for trouble-free exchange of filters. However, various other end cap shapes are contemplated. The end cap 200 is located at each end of the PLF unit base 110.

FIGS. 8A and. 8B illustrate front and side views respectively of a bulb socket mounting panel 300. The bulb socket mounting panel 300 contains at least one female structure 3.10 to accommodate one or more illumination elements (e.g., illumination elements 190, 192). The shape of the bulb socket mounting panel 300 is generally similar to the end cap 200 such that they are similarly mounted and oriented. However, the end cap 200 is mounted externally to the bulb socket mounting panel 300. It is to be appreciated that the bulb socket mounting panel 300 can include a plurality of female structures 310 to accommodate a plurality of illumination elements.

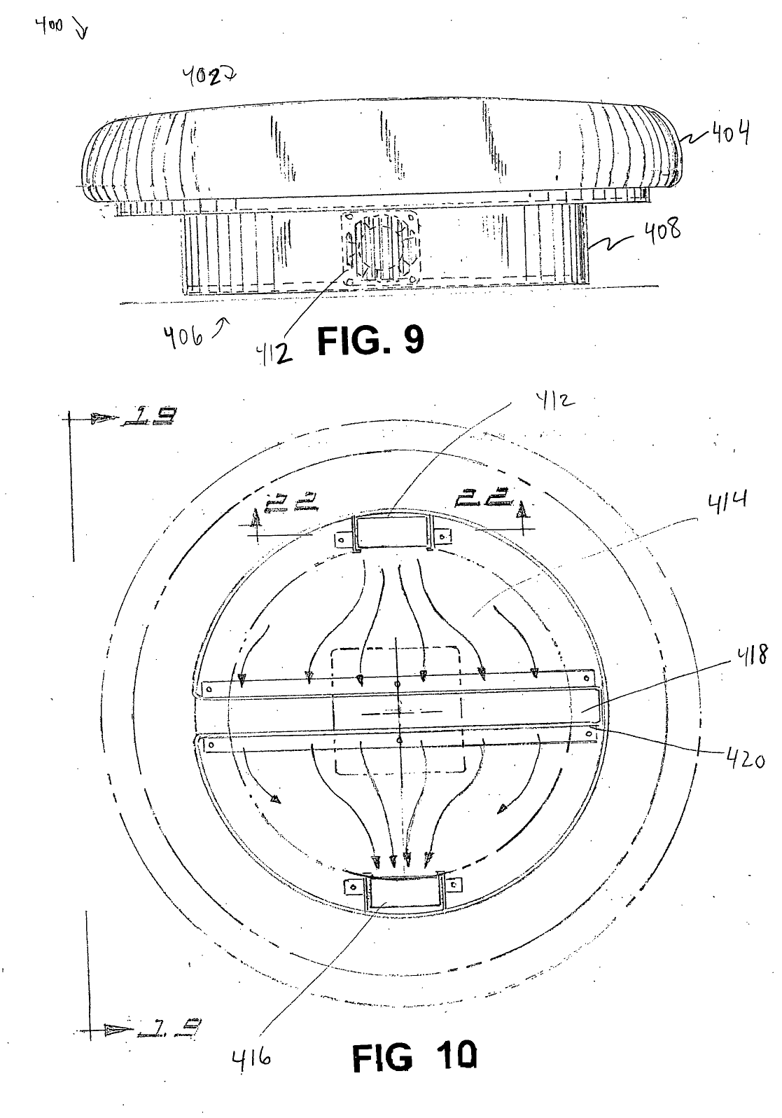

FIG. 9 shows a side profile of a circular lamp and air filtration unit 400. The top portion 402 is a diffuser 404 which houses one or more illumination elements. The bottom portion 406 is a base 408 that contains an input fan 412 wherein air can be drawn into the unit 400 and subsequently expelled from the unit 400 after filtration. The air can be filtered utilizing any number of filtration elements such as a HEPA filter, a charcoal filter, an electrostatic filter and the like. The base 408 can house electrical components required for operation such as a PC board, a fan speed regulator and a ballast. In addition, the base 408 can have an opening in the unit to allow wiring or other cabling to pass into the circular lamp and air filtration unit 400.

FIG. 10 shows a top view of the circular lamp and air filtration unit 400 which illustrates the air flow through the air filtration portion of the unit 400. Air is drawn into the unit via the input fan 412, through a conduit 414 and expelled via an output fan 416. The conduit 414 has a circular shape that conforms generally to the shape of the base 408. However, in another approach the conduit 414 can be substantially any polygonal shape. For example, the diffuser 404 and/or the conduit 414 can be shaped octagonal, hexagonal, circular, elliptical or oval.

A filtration element 418 is located substantially in the center of the conduit 414 and is held in place by a filter guide 420. In this manner, the filtration element 418 has a cross-section across the diameter of the conduit 414. Alternatively, other filtration element 418 locations can be employed. The filtration element 418 can be easily removed from the side of the unit 400 via the filter guide 420 and replaced and/or cleaned for future use. The diffuser 404 has a greater diameter than the base and can contain one or more lamps that coil around the circumference of the unit 400. The circular lamp and air filtration unit 400 can be oriented based on any number of factors such as air flow, location of unit, etc.

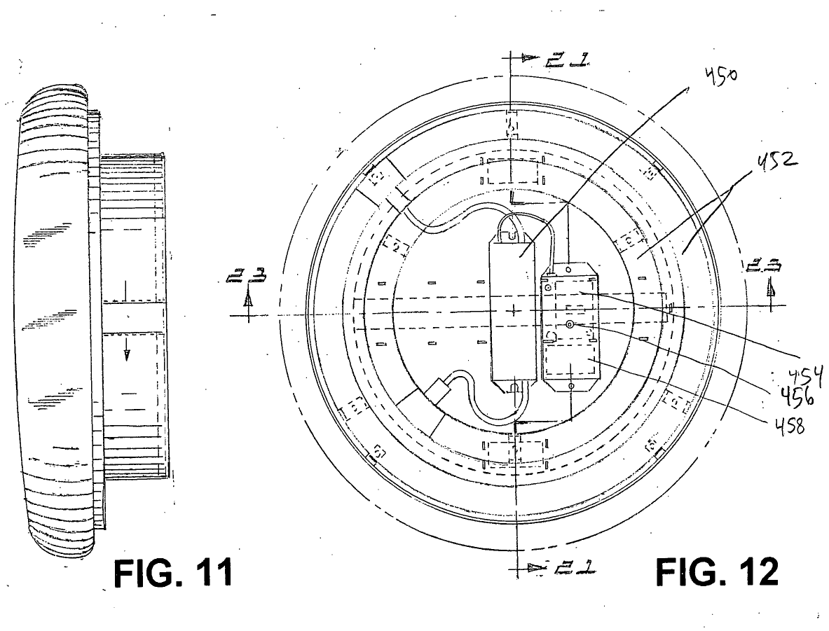

FIG. 11 illustrates a side profile of the circular lamp and air filtration unit 400. This view is orthogonal to the view shown in FIG. 9 and illustrates access to the filtration element 418 via the filter guide 420. As noted, in one embodiment, the filtration element 418 is located substantially close to the diameter of the circular lamp and air filtration unit 400. The filtration element 418 can have a tab or other member attached to allow a user to extract the filtration element 418 from the filter guide 420.

FIG. 12 shows a detailed top view of the circular lamp and air filtration unit 400. A ballast 450 delivers power to an illumination element 452. In this embodiment, the illumination element 452 consists of two circline fluorescent bulbs. In another embodiment, the illumination element can be substantially any shape of bulb. A filter replace timer PC board 454 (PC board) is coupled to an LED indicator lamp 456 which is illumiated when a predetermined condition is met. A fan speed regulator 458 is coupled to the input and/or output fans 412 and 416 wherein fan speed is regulated based on any number of conditions such as, for example, quality of air in the conduit 414, life of the filtration element 418, etc.

In this embodiment, the illumination element 452 is comprised of two fluorescent bulbs that are concentric to each other with similar center points. However, it is to be appreciated that the illumination element can be substantially any lamp including, for example, a circline fluorescent lamp, a linear fluorescent lamp, a u-bent fluorescent lamp, a halogen lamp, an incandescent lamp, a high intensity discharge lamp, a mercury vapor lamp, a halogen lamp, a xenon lamp or a sodium lamp.

The LED indicator lamp 456 is located within the diameter of the two fluorescent lamps such that it can be illuminated and located when a predetermined condition is met. The LED indicator lamp 456 is coupled to the PC board 454. The PC board 454 can be programed to send a signal to the LED indicator lamp 456 when a predetermined condition is met. Such condition can be an indication that the filter needs to be replaced or cleaned, that an illumination element needs to be replaced or any other condition. Once the condition is addressed, the PC board 454 can be reset to toggle the LED indicator lamp 456 to an off state.

The illumination element 452 is enclosed by the diffuser 404 that provides a homogenous output from the illumination element 452. The diffuser 404 can be any material that allows light to pass through such as translucent plastic or glass. In addition, the diffuser 404 can be substantially any color to match a particular design scheme. Spring clips (not shown) can be employed to hold the diffuser 404 to the base 408 of the circular lamp and air filtration unit 400. The spring clips can be spaced around the circumference of the circular lamp and air filtration unit 400 in order to provide secure mechanical coupling of the diffuser 404 to the base 408 of the unit 400.

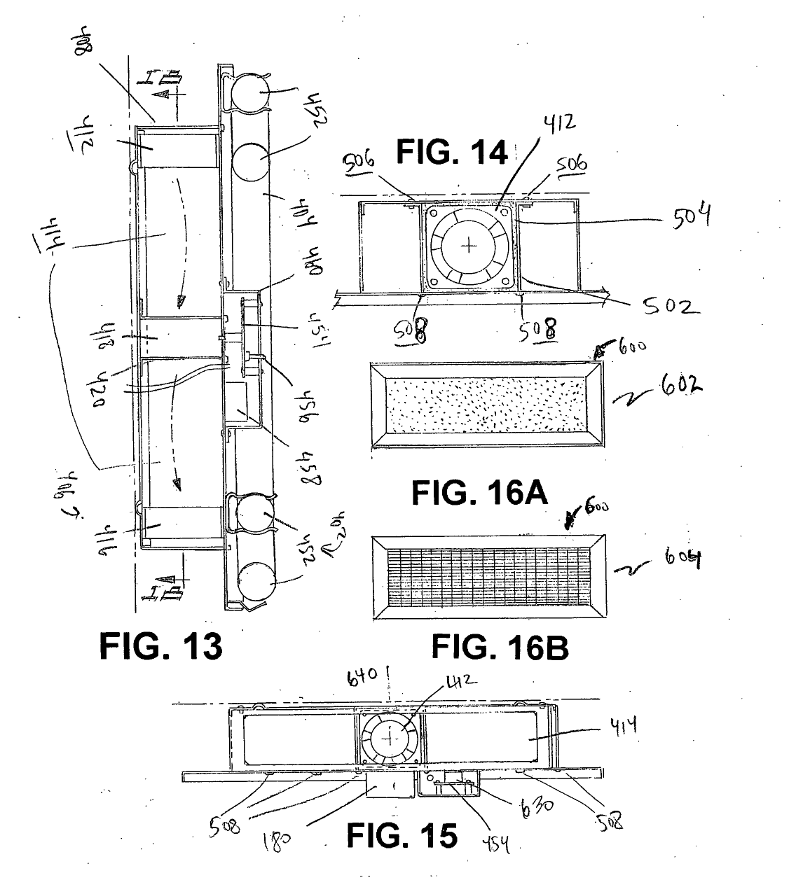

FIG. 13 shows a cross section of the circular lamp and air filtration unit 400 as provided in FIG. 12. The illumination element 452 is located within the lamp housing 404 at the top 402 of the circular lamp and air filtration unit 400. An enclosure 460 houses the PC board 454, the LED indicator lamp 456 and the fan speed regulator 458. The enclosure 460 can be manufactured of durable material that provides structural stability, such as metal or plastic for example. The input fan 412 draws air through the conduit 414 which contains the filtration element 418 fixed in place via the filter guide 420. The output fan 416 draws the filtered air out of the conduit 414.

FIG. 14 illustrates the input fan 412. Although only the input fan 412 is shown, it is to be appreciated that the output fan 416 is substantially the same as the input fan 412 in size and power consumption. The input fan 412 is fixed in place via a fan bracket 502 located on either side of the fan 412. The top side 402 of the fan bracket 502 is mechanically coupled to the base 408 via at least one fastener 506. The fastener can be a rivet, screw or other device that provides coupling between the fan bracket 502 and the base 408. The bottom side 406 of the fan bracket is coupled to the base 408 via at least one deformed tab 508 or similar means. Foam rubber or other material can be positioned between the input fan 412 and the fan bracket 502 to provide sound insulation and to act as an air seal. By providing such an air seal, the input fan 412 can operate at a higher level of efficiency.

FIG. 15 shows a cross section view of the circular lamp and air filtration unit 400 as shown in FIG. 12 above. The output fan 412 draws filtered air from the conduit 414. In this embodiment, the ballast 180 is located below the conduit 414 and output fan 412 at approximately the centerline 640 of the circular lamp and air filtration unit 400. The filter replace timer PC board 454 is located adjacent to the ballast. A filter reset switch 650 is electrically coupled to the PC board 454. The filter reset switch 650 can be employed to reset the LED indicator lamp 456 to an off state and to reset any condition associated therewith. In one example, the filter reset switch 650 is employed to reset a timer (not shown) which is associated with the length of time a particular filter has been in service.

FIGS. 16A and 16B illustrate two views (front and back) of a combination air filter 600. In particular, FIG. 16A illustrates a first side 602 of the air filter 600 and FIG. 16B illustrates a second side 604 of the air filter 600. Each side can be employed to filter disparate matter from the air. The combination air filter 600 can vary dimensionally and can be configured in substantially any shape. The combination air filter 600 can be employed to filter particulates, odors and other desired matter from the air. In one embodiment, the first side 602 is a HEPA filter and the second side 604 is a charcoal filter. In another approach, the first side 602 and the second side 604 are electrostatic. It is to be appreciated by one skilled in the art that although various embodiments have been disclosed herein, other embodiments may be contemplated.

1. A lighting unit, comprising:
an illumination element;
a housing with a rounded profile that encloses the illumination element;
a conduit that is adjacent to the housing;
a filter that is mounted within the conduit;
an input fan that draws air through the filter to produce filtered air; and
an output fan that expels the filtered air.

2. The lighting unit of claim 1, wherein the housing is made from a translucent material.

3. The lighting unit of claim 1, wherein the filter is at least one of a high efficiency particulate air filter, an electrostatic filter and a charcoal filter.

4. The lighting unit of claim 1, wherein the illumination element is at least one of a fluorescent bulb, an incandescent bulb, a high intensity discharge bulb and a compact fluorescent bulb.

5. The lighting unit of claim 1, further including:
a ballast that delivers external power to the illumination element.

6. The lighting unit of claim 1, further including:
a signal lamp that indicates when a condition exists that requires attention from a user.

7. The lighting unit of claim.6, further including:
a personal computer board that is programmed to toggle the signal lamp based on a predetermined condition.

8. The lighting unit of claim 7, wherein the signal lamp is a light emitting diode.

9. The lighting unit of claim 7 wherein the condition is at least one of filter replacement, illumination element replacement, fan malfunction and fan replacement.

10. The lighting unit of claim 1, further including:
a fan speed regulator that controls the speed of the input fan and the output fan.

11. The lighting unit of claim 10, wherein the speed of the input fan and the output fan is based on at least one of a time interval, quality of air and length of filter use.

12. The lighting unit of claim 11, further including:
a filter reset switch that interfaces with the personal computer board to reset one or more predetermined filter values.

13. A lighting unit, comprising:
an illumination element;
a diffuser with a rounded profile that encloses the illumination element;
a conduit that is adjacent to the housing;
a combination HE?PA-charcoal filtration element that is mounted within the conduit;
an input fan that draws air through the filtration element to produce filtered air; and
an output fan that expels the filtered air.

14. The lighting unit of claim 13 wherein the diffuser is shaped one of octagonal, hexagonal, circular, elliptical and oval.

15. The lighting unit of claim 13 wherein the conduit is shaped one of octagonal, hexagonal, circular, elliptical and oval.

16. The lighting unit of claim 13 wherein the illumination element is at least one of a circline fluorescent lamp, a linear fluorescent lamp, a u-bent fluorescent lamp, a halogen lamp, an incandescent lamp, a high intensity discharge lamp, a mercury vapor lamp, a halogen lamp, a xenon lamp and a sodium lamp.

17. The lighting unit of claim 13, wherein an air seal surrounds at least one of the input fan and output fan.

18. The lighting unit of claim 13, further including:
a filtration element guide that fixes the location and allows removal of the filtration element.

19. A multi-function appliance, comprising:
at least one light bulb;
a housing with that encloses the illumination element,
an indication lamp that is proximate the illumination element;
a personal computer board that illuminates the indication lamp based on at least one predetermined condition;
a conduit that is adjacent to the housing;
a combination HEPA-charcoal filtration element that is mounted within the conduit;
an input fan that draws air through the filtration element to produce filtered air;
an output fan that expels the filtered air; and
a fan speed regulator that varies the speed of at least one of the input fan and the output fan.

20. The multi-function appliance of claim 19, wherein the predetermined condition is at least one of filter replacement, illumination element replacement, fan malfunction and fan replacement.
